(19) United States
(12) Patent Application Publication
(10) Pub. No.: US 2026/0229205 A1
(43) Pub. Date: Aug. 6, 2026

(54) BASS DRUM PAD

(71) Applicant: HOSHINO GAKKI CO., LTD., Nagoya (JP)

(72) Inventor: Hideyuki MIYAJIMA, Nagoya (JP)

(21) Appl. No.: 19/283,262

(22) Filed: Jul. 29, 2025

(30) Foreign Application Priority Data
Jan. 24, 2025 (JP) 2025-010474

(51) Int. Cl. G10D 13/10; G10D 13/20; G10D 13/03; G10D 13/14

(52) U.S. Cl. CPC G10D 13/26; G10D 13/20; G10D 13/03; G10D 13/14

(57) ABSTRACT

A bass drum pad includes a support, an impact receiving unit, a guide mechanism, and a cushion member. The impact receiving unit includes a pad body that is struck by a beater. The impact receiving unit is supported so as to be movable relative to the support. The guide mechanism guides the impact receiving unit to move in the guide direction relative to the support when the pad body is struck. The cushion member is placed between the impact receiving unit and the support. The cushion member absorbs the impact acting on the impact receiving unit.

### CROSS-REFERENCE TO RELATED APPLICATIONS

This application is based upon and claims the benefit of priority from Japanese Patent Application No. 2025-010474, filed on January 24, 2025, the entire contents of which are incorporated herein by reference.

### BACKGROUND

### 1. Field

The present disclosure relates to a bass drum pad.

### 2. Description of Related Art

Japanese Laid-Open Patent Publication No. 2019-128372 discloses an electronic bass drum that is played using a striking mechanism including a beater, which swings in response to a stepping operation by the player. The electronic bass drum includes a head, which includes a striking surface, and a stand, which supports the head.

The head includes, at its outer circumference, attachment portions protruding outward. A head connector, which is a bolt extending perpendicular to the striking surface of the head, extends through each attachment portion. The head connector is threaded in a lug located opposed to the attachment portion of the head. A cylindrical damper member is attached to at least one of the head connectors and is placed between the attachment portion and the lug. The head connector is inserted in the damper member.

The stand includes a planar stand body, which stands vertically and extends along the striking surface of the head. The stand body has through-holes, through which the head connectors extend and into which the damper members fit. The diameter of the through-hole is larger than the diameter of the head connector and is substantially the same as the diameter of the damper member.

The damper members are fitted into the through-holes, so that the head is elastically supported on the stand. Accordingly, when the beater strikes the head, the head moves forward relative to the stand in the striking direction of the beater, thereby compressing the damper members in the axial direction. This absorbs the impact that acts on the head when it is struck.

The diameter of the through-hole of the stand body is larger than the diameter of the head connector and is substantially the same as the diameter of the damper member. Also, a damper member is interposed between the outer circumference surface of the head connector and the inner circumference surface of the through-hole. Thus, the head connector can move inside the through-hole while compressing the damper member. As a result, when the head is struck, the head may move not only in the axial direction of the damper member, but also in a direction different from the axial direction. For example, when the striking position of the beater is away from the center of the striking surface of the head, or when a twin pedal strikes two separate points on the striking surface, the damper members may be compressed while the head is tilted, causing the head to vibrate. In particular, when the head is struck repeatedly and quickly by the beater, the vibration of the head becomes more noticeable. This may cause the player to experience a sense of discomfort.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a bass drum pad is configured to be played using a pedal device including a beater that swings in response to a stepping operation by a player. The bass drum pad includes a support, an impact receiving unit, a guide mechanism, and an impact absorption portion. The impact receiving unit includes a pad body that is configured to be struck by the beater. The impact receiving unit is supported so as to be movable relative to the support. The guide mechanism is configured to guide the impact receiving unit to move in a guide direction relative to the support when the pad body is struck. The impact absorption portion is placed between the impact receiving unit and the support to absorb an impact acting on the impact receiving unit.

In another general aspect, a bass drum pad is configured to be played using a pedal device including a beater that swings in response to a stepping operation by a player. The bass drum pad includes a support, an impact receiving unit, and a bracket. The impact receiving unit includes a pad body that is configured to be struck by the beater. The impact receiving unit is supported by the support. The bracket is attachable to a support column of a stand supporting a percussion instrument that is different from the bass drum pad. The support includes an extension portion extending toward the bracket and a clamped portion that is configured to be sandwiched from above and below by a clamp of the pedal device. The bracket includes a support portion that supports the extension portion from below. The bass drum pad is configured to be separated from an installation surface of the pedal device when the extension portion is supported by the support portion from below and the clamped portion is sandwiched by the clamp.

Other features and aspects will be apparent from the following detailed description, the drawings, and the claims.

### BRIEF DESCRIPTION OF THE DRAWINGS

FIG. 1 is a perspective view of an electronic drum set.

FIG. 2 is a perspective view of a bass drum pad.

FIG. 3 is an exploded perspective view of the bass drum pad shown in FIG. 2.

FIG. 4 is a cross-sectional view of an extension portion and a bracket of FIG. 2.

FIG. 5 is a cross-sectional view of the extension portion and the bracket of FIG. 2.

FIG. 6 is a perspective view of the bracket shown in FIG. 2.

FIG. 7 is a cross-sectional view of the bracket shown in FIG. 2.

FIG. 8 is a side view of the bass drum pad shown in FIG. 2.

FIG. 9 is a side view of the bass drum pad being struck.

FIG. 10 is a side view of a bass drum pad connected to a pedal device on a vibration isolation member.

FIG. 11 is a side view of a bass drum pad of a first modification.

FIG. 12 is a cross-sectional view of a bass drum pad of a second modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

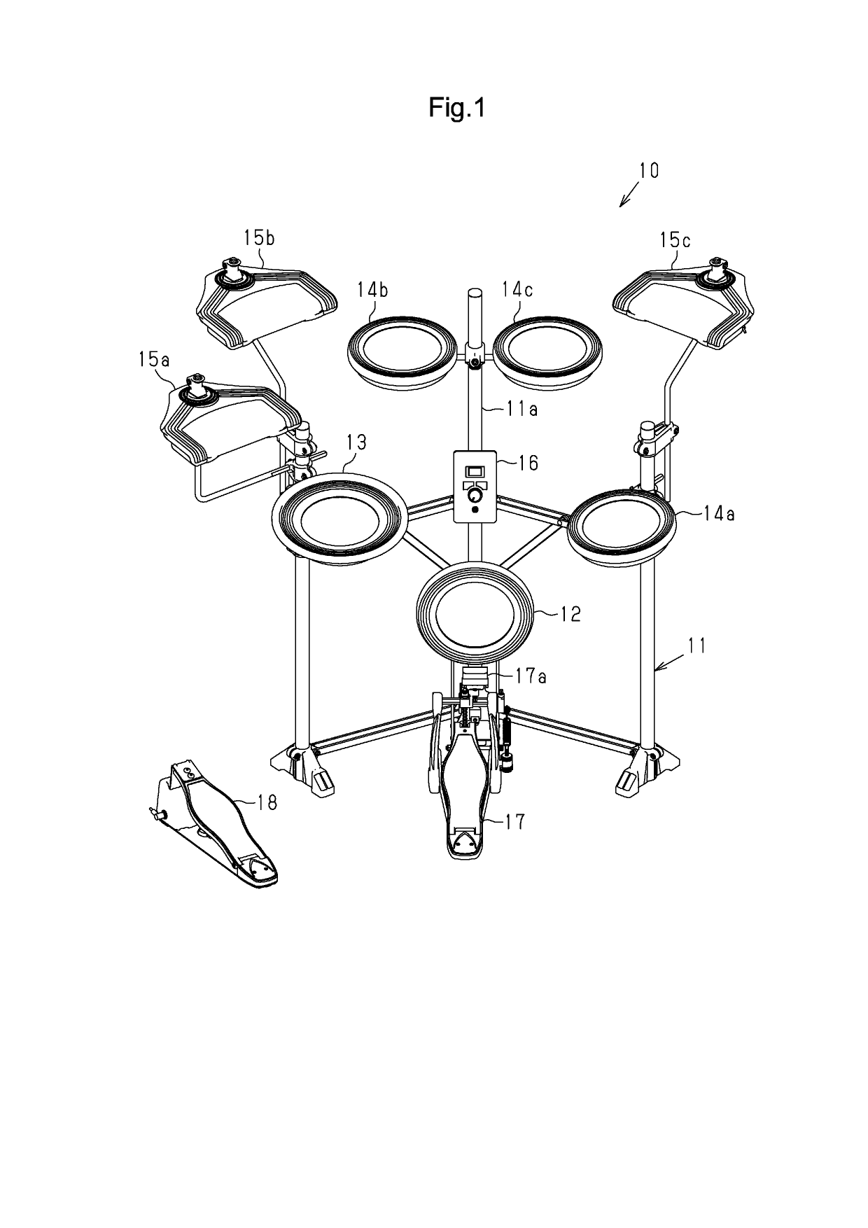

Referring to FIGS. 1 to 10, a bass drum pad according to one embodiment forming an electronic drum set is described below.

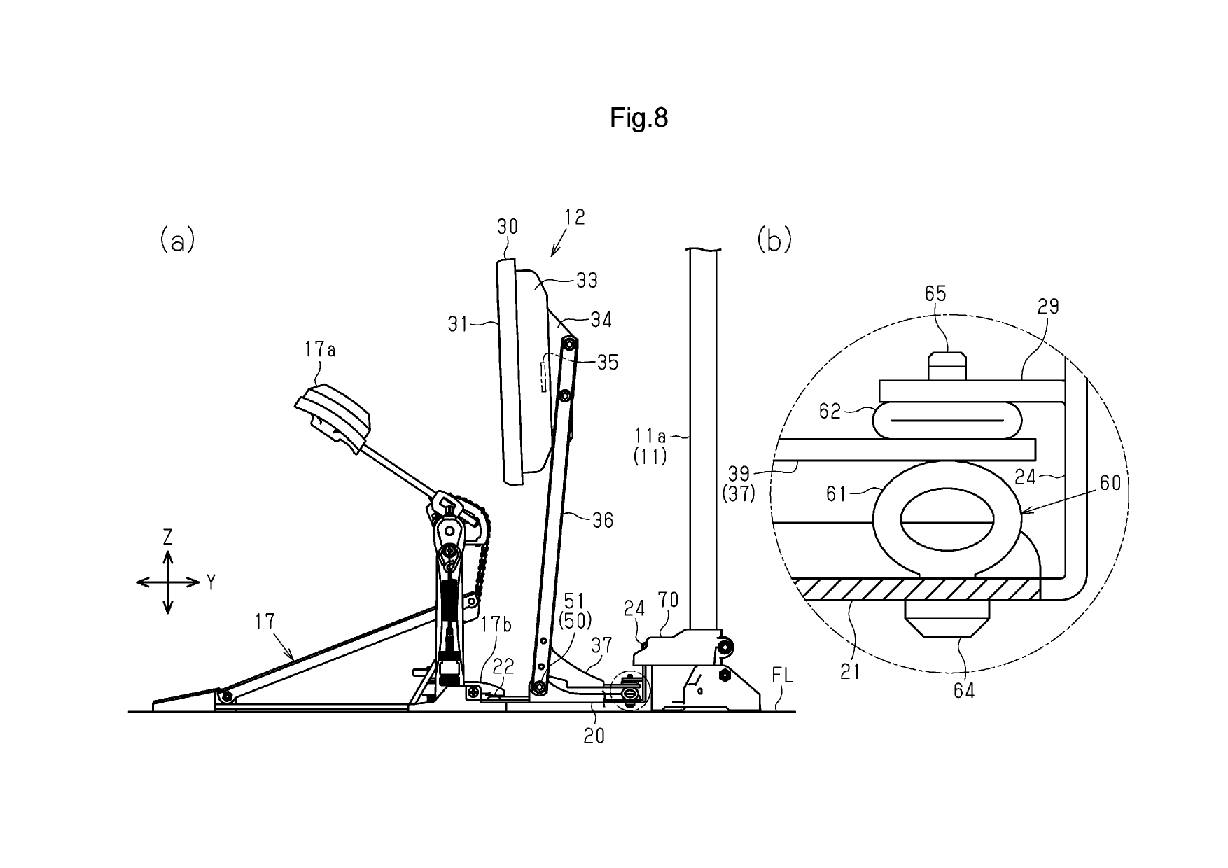

As shown in FIG. 1, an electronic drum set 10 includes a stand 11, a bass drum pad 12, a snare drum pad 13, a floor tom pad 14a, a first tom pad 14b, a second tom pad 14c, a hi-hat cymbal pad 15a, a first cymbal pad 15b, and a second cymbal pad 15c. The stand 11 is placed on an installation surface FL (see part (a) of FIG. 8). The stand 11 supports the pads. The bass drum pad 12 is an example of an electronic bass drum pad.

The electronic drum set 10 includes a sound source device 16, which produces sounds based on the output signals of vibration sensors provided on the pads. The sound source device 16 is attached to the stand 11. The sound source device 16 is connected to the vibration sensors of the pads by cables (not shown).

The pads other than the bass drum pad 12 are played by the player by striking them with a stick (not shown). The bass drum pad 12 is played with a pedal device 17 including a beater 17a, which swings in response to a stepping operation by the player. The hi-hat cymbal pad 15a produces a different tone when struck depending on the presence or absence of a stepping operation of a hi-hat pedal 18 by the player.

### Configuration of Bass Drum Pad 12

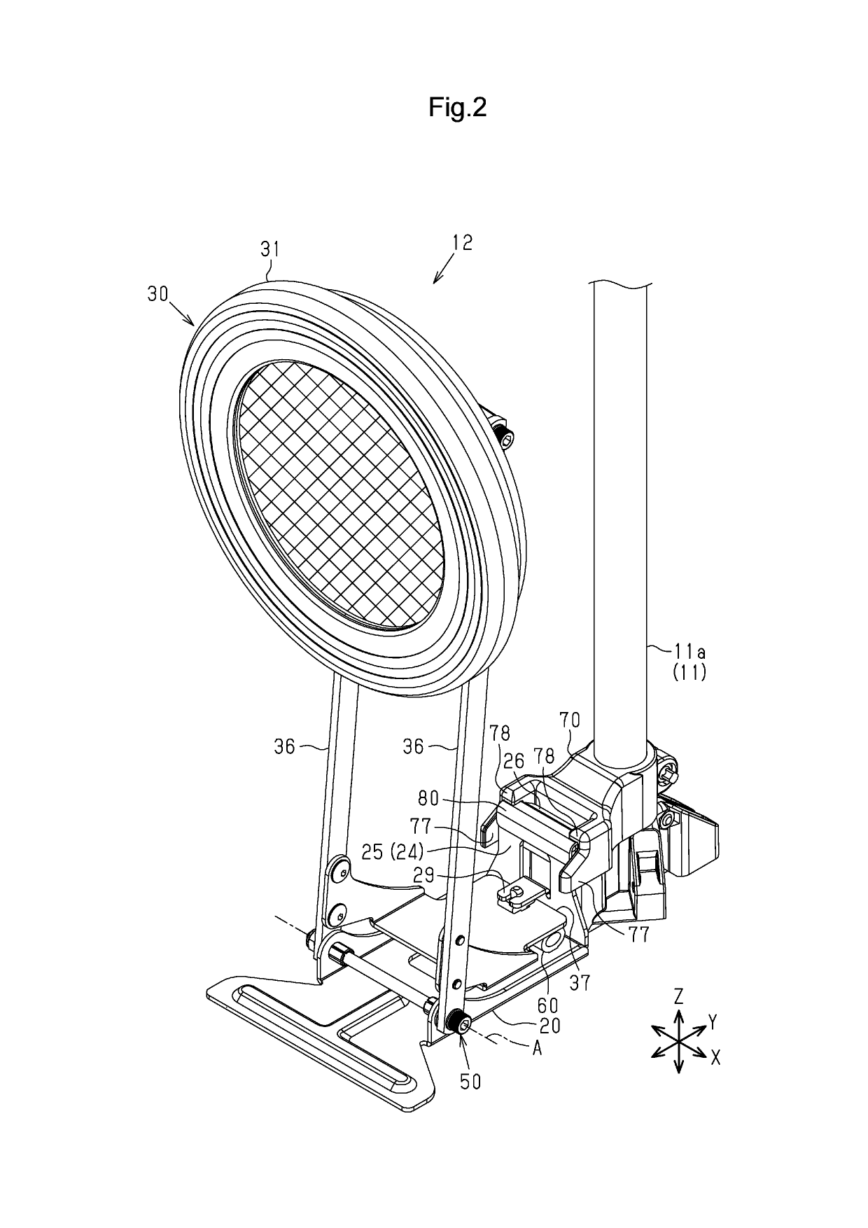

As shown in FIG. 2, the bass drum pad 12 includes a support 20, an impact receiving unit 30, a guide mechanism 50, a cushion member 60, and a bracket 70. The impact receiving unit 30 includes a pad body 31, which is struck by the beater 17a. The impact receiving unit 30 is supported so as to be movable, more specifically, rotatable, relative to the support 20. The guide mechanism 50 guides the impact receiving unit 30 to move in a guide direction relative to the support 20 when the pad body 31 is struck. The cushion member 60 is placed between the impact receiving unit 30 and the support 20 and absorbs the impact applied to the impact receiving unit 30. The bracket 70 connects the support 20 to a support column 11a of the stand 11. As shown in FIG. 1, the support column 11a supports the first tom pad 14b and the second tom pad 14c, which are percussion instruments different from the bass drum pad 12.

In the following description, directions extending along the X-axis, Y-axis, and Z-axis shown in some of the drawings will be referred to as the X-axis direction, the Y-axis direction, and the Z-axis direction, respectively. The X-axis direction, the Y-axis direction, and the Z-axis direction are perpendicular to each other. The Y-axis direction is the direction in which the pedal device 17 and the bass drum pad 12 are aligned. The Z-axis direction is the vertical direction. Also, with respect to the bass drum pad 12, a direction away from the pedal device 17 in the Y-axis direction is referred to as frontward, and the direction toward the pedal device 17 in the Y-axis direction is referred to as rearward.

### Configuration of Support 20

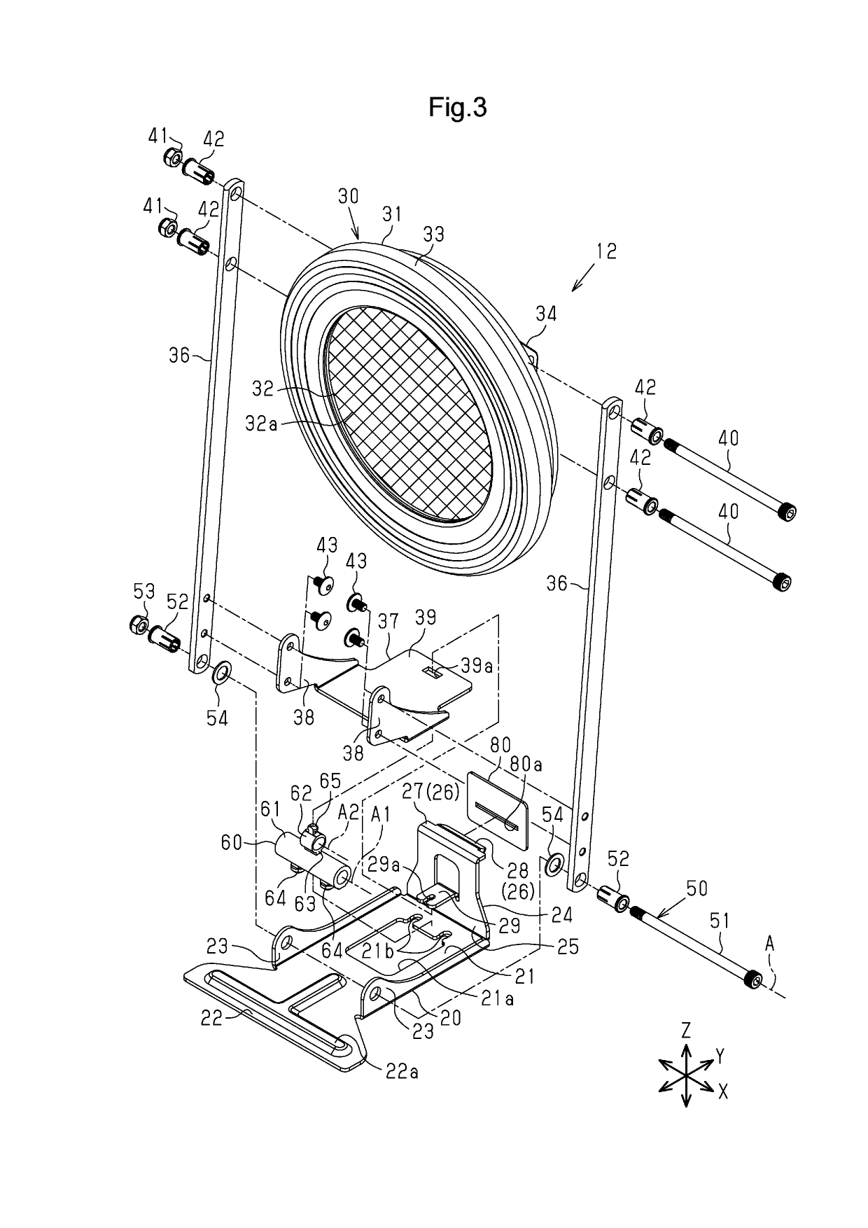

As shown in FIG. 3, the support 20 includes a base portion 21, two support walls 23, and an extension portion 24.

The base portion 21 has the shape of a flat plate having a thickness direction in the Z-axis direction. The base portion 21 has a rectangular through-hole 21a, which extends through the base portion 21 in the Z-axis direction, and two first slits 21b, which are spaced apart from each other in the X-axis direction. The first slits 21b extend forward from the front edge of the through-hole 21a.

The rear end section of the base portion 21 includes a clamped portion 22, which is sandwiched from above and below by a clamp 17b of the pedal device 17 (see part (a) of FIG. 8). The clamped portion 22 includes a rib 22a extending upward to reinforce the rear end section of the base portion 21.

The support walls 23 extend upward from opposite edges in the X-axis direction of the base portion 21 and face each other in the X-axis direction. The support walls 23 extend in the Y-axis direction.

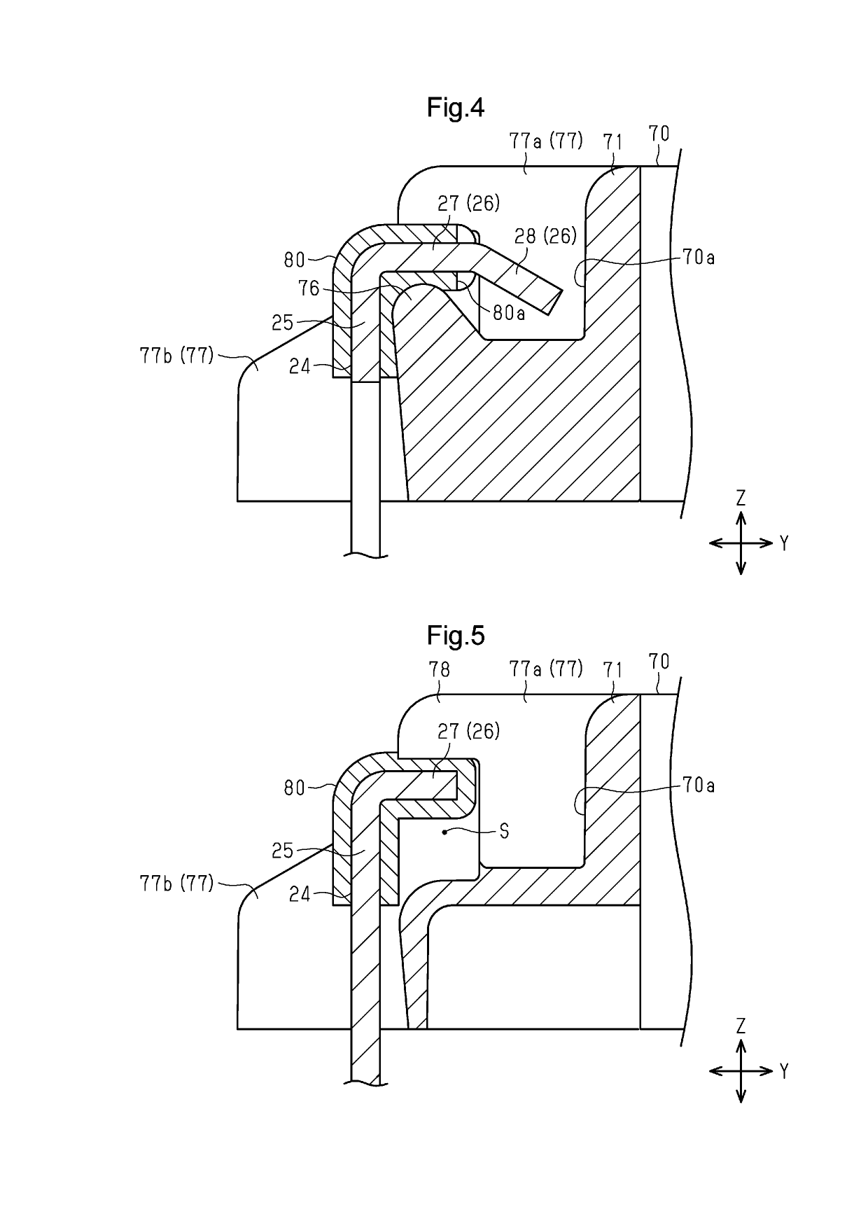

As shown in FIGS. 2 and 4, the extension portion 24 extends from the front end of the base portion 21 toward the bracket 70.

The extension portion 24 includes a restriction portion 25 and a protruding portion 26. The restriction portion 25 extends upward in the Z-axis direction from the front end of the base portion 21. The protruding portion 26 extends from the upper end of the restriction portion 25 toward the bracket 70 in the Y-axis direction. The bracket 70 supports the protruding portion 26 from below.

The restriction portion 25 is on the opposite side of the bracket 70 from the support column 11a in the Y-axis direction; that is, on the rear side. The restriction portion 25 is opposed to the bracket 70 and restricts movement of the support 20 toward the support column 11a.

As shown in FIG. 4, the protruding portion 26 includes a first section 27 and a second section 28. The first section 27 extends forward from the upper end of the restriction portion 25. The second section 28 extends from the front end of the first section 27 and is inclined downward to the front with respect to the first section 27. As shown in FIG. 3, the width of the second section 28 in the X-axis direction is less than the width of the first section 27 in the X-axis direction.

The base portion 21 includes an opposing portion 29, which is located above a stopper 37 (described below) and opposed to the stopper 37. The opposing portion 29 is formed by cutting and raising a part of the restriction portion 25 toward the side opposite to the protruding portion 26 in the Y-axis direction; that is, rearward. The opposing portion 29 extends from the restriction portion 25 in parallel to the base portion 21. The opposing portion 29 has a second slit 29a extending forward from the rear end of the opposing portion 29. The second slit 29a is located between the two first slits 21b as viewed from the Z-axis direction.

As shown in FIGS. 4 and 5, a cushioning member 80 is attached with an adhesive (not shown) to the section of the extension portion 24 that comes into contact with the bracket 70. The cushioning member 80 may be a sheet of felt, for example. The cushioning member 80 covers the front and rear surfaces of the upper end section of the restriction portion 25 and also covers the upper and lower surfaces of the first section 27.

As shown in FIG. 3, the cushioning member 80 has an insertion hole 80a, into which the protruding portion 26 is inserted. The cushioning member 80 is attached to the extension portion 24 by being folded so as to cover the restriction portion 25 and the first section 27 with the protruding portion 26 inserted in the insertion hole 80a.

### Configuration of Impact Receiving Unit 30

The impact receiving unit 30 includes a pad body 31, two arms 36, and a stopper 37.

The pad body 31 includes an elastic body 32, which includes an impact receiving surface 32a to be struck by the player, and a case 33, which houses the elastic body 32. The elastic body 32 is disc-shaped. The elastic body 32 may include sponge and a mesh member provided on the surface of the sponge, for example. The case 33 has an opening through which the impact receiving surface 32a is exposed. The bottom wall of the case 33 includes an attachment portion 34, to which the arms 36 are fixed (see FIG. 8A). The impact receiving unit 30 is supported by the support 20 with the impact receiving surface 32a oriented generally perpendicular to the Y-axis direction.

The arms 36 are fixed to the attachment portion 34 and the support walls 23 from the opposite sides in the X-axis direction. The arms 36 extend linearly and parallel to each other.

The upper ends of the arms 36 are fixed to the attachment portion 34 by two bolts 40 and two nuts 41 attached to the bolts 40. The bolts 40 are arranged in the length direction of the arms 36 and extend through the arms 36 and the attachment portion 34. Each bolt 40 extends through the two arms 36 and is inserted in two cylindrical collars 42, which are inserted in the attachment portion 34. That is, two collars 42 are interposed between each bolt 40 and the two arms 36.

The bolts 40 are made of a metal material. The collars 42 are made of a plastic material. The collars 42 serve to prevent generation of contact noise between the bolts 40 and the arms 36.

The lower ends of the arms 36 are rotationally supported by the support walls 23 through a support shaft 51, which will be described below. The arms 36 extend in a direction intersecting the support shaft 51; more specifically, in a direction perpendicular to the support shaft 51.

The stopper 37 extends from the arms 36 and rotates together with the arms 36. The stopper 37 includes two fixing portions 38 and a push plate portion 39. The fixing portions 38 are fixed to the respective arms 36 by screws 43. The fixing portions 38 extend forward from the arms 36. The push plate portion 39 connects the front ends of the fixing portions 38 to each other. The push plate portion 39 has the shape of a flat plate having a thickness direction in the Z-axis direction. The push plate portion 39 is opposed to the upper surface of the base portion 21. The front end of the push plate portion 39 includes an attachment hole 39a extending through the push plate portion 39 in the Z-axis direction.

The push plate portion 39 is configured to move toward and away from the upper surface of the base portion 21 as the impact receiving unit 30 rotates about the support shaft 51.

As shown in part (a) of FIG. 8, the impact receiving unit 30 includes a vibration sensor 35, which detects vibration of the pad body 31. The vibration sensor 35 is placed inside the case 33 between the bottom wall of the case 33 and the elastic body 32. More specifically, the vibration sensor 35 detects vibrations of the elastic body 32 when the elastic body 32 is struck, and outputs signals to the sound source device 16 according to the magnitude of the vibrations.

### Configuration of Guide Mechanism 50

As shown in FIG. 3, the guide mechanism 50 includes a support shaft 51, which supports the impact receiving unit 30 such that the impact receiving unit 30 can rotate relative to the support 20 about an axis A extending in the X-axis direction. The support shaft 51 is a bolt that rotationally supports the lower ends of the arms 36 relative to the support 20.

The support shaft 51 allows movement of the impact receiving unit 30 in opposite circumferential directions about the axis A, while restricting movement of the impact receiving unit 30 in directions other than the opposite circumferential directions. Thus, the support shaft 51 guides the impact receiving unit 30 to move in a guide direction that is one of the rotation directions about the axis A. The guide direction in this embodiment is the frontward rotation direction of the impact receiving unit 30 struck by the beater 17a.

The guide mechanism 50 includes two collars 52 and a nut 53. Each collar 52 extends through the arm 36 and the support wall 23. The collar 52 also extends through a washer 54 placed between the arm 36 and the support wall 23. The support shaft 51 is inserted in the two arms 36, the two washers 54, and the two support walls 23. The nut 53 is attached to the distal end of the support shaft 51.

When the impact receiving unit 30 rotates about the axis A of the support shaft 51, the arms 36 slide relative to the collars 52. As such, the support shaft 51 does not rotate when the impact receiving unit 30 rotates.

The support shaft 51 is made of a metal material. The collars 52 and the washers 54 are made of a plastic material. The collars 52 serve to prevent generation of contact noise between the support shaft 51 and the arms 36. The washers 54 serve to prevent generation of contact noise between the arms 36 and the support walls 23.

### Configuration of Cushion Member 60

The cushion member 60 includes a first impact absorption portion 61, a second impact absorption portion 62, a connection portion 63, a pair of first support protrusions 64, and a second support protrusion 65. The first impact absorption portion 61, the second impact absorption portion 62, the connection portion 63, the first support protrusions 64, and the second support protrusion 65 are integrally formed from rubber.

The first impact absorption portion 61 has the shape of a hollow cylinder having a central axis A1 extending in the X-axis direction. The central axis A1 of the first impact absorption portion 61 is parallel to the axis A of the support shaft 51. The first impact absorption portion 61 is placed between the lower surface of the stopper 37 and the upper surface of the base portion 21.

The second impact absorption portion 62 has the shape of a hollow cylinder having a central axis A2 extending in the X-axis direction. The central axis A2 of the second impact absorption portion 62 is parallel to the central axis A1 of the first impact absorption portion 61. The second impact absorption portion 62 is placed between the upper surface of the stopper 37 and the lower surface of the opposing portion 29. The length of the second impact absorption portion 62 in the X-axis direction is shorter than the length of the first impact absorption portion 61 in the X-axis direction. The thickness of the second impact absorption portion 62 is less than the thickness of the first impact absorption portion 61.

The connection portion 63 connects the upper part of the first impact absorption portion 61 to the lower part of the second impact absorption portion 62. The connection portion 63 is located at the center of the first impact absorption portion 61 in the X-axis direction. The width of the connection portion 63 in the X-axis direction is the same as the length of the second impact absorption portion 62 in the X-axis direction. The connection portion 63 is placed inside the attachment hole 39a of the push plate portion 39. The second impact absorption portion 62 is inserted into the attachment hole 39a while being compressed, so that the connection portion 63 is placed inside the attachment hole 39a. The cushion member 60 is thus attached to the stopper 37.

The first support protrusions 64 are spaced apart from each other in the X-axis direction and protrude downward from the lower part of the first impact absorption portion 61. The first support protrusions 64 are engaged with the respective first slits 21b. The first impact absorption portion 61 is thus supported relative to the base portion 21.

The second support protrusion 65 protrudes upward from the upper part of the second impact absorption portion 62. The second support protrusion 65 is engaged with the second slit 29a. The second impact absorption portion 62 is thus supported relative to the opposing portion 29.

### Configuration of Bracket 70

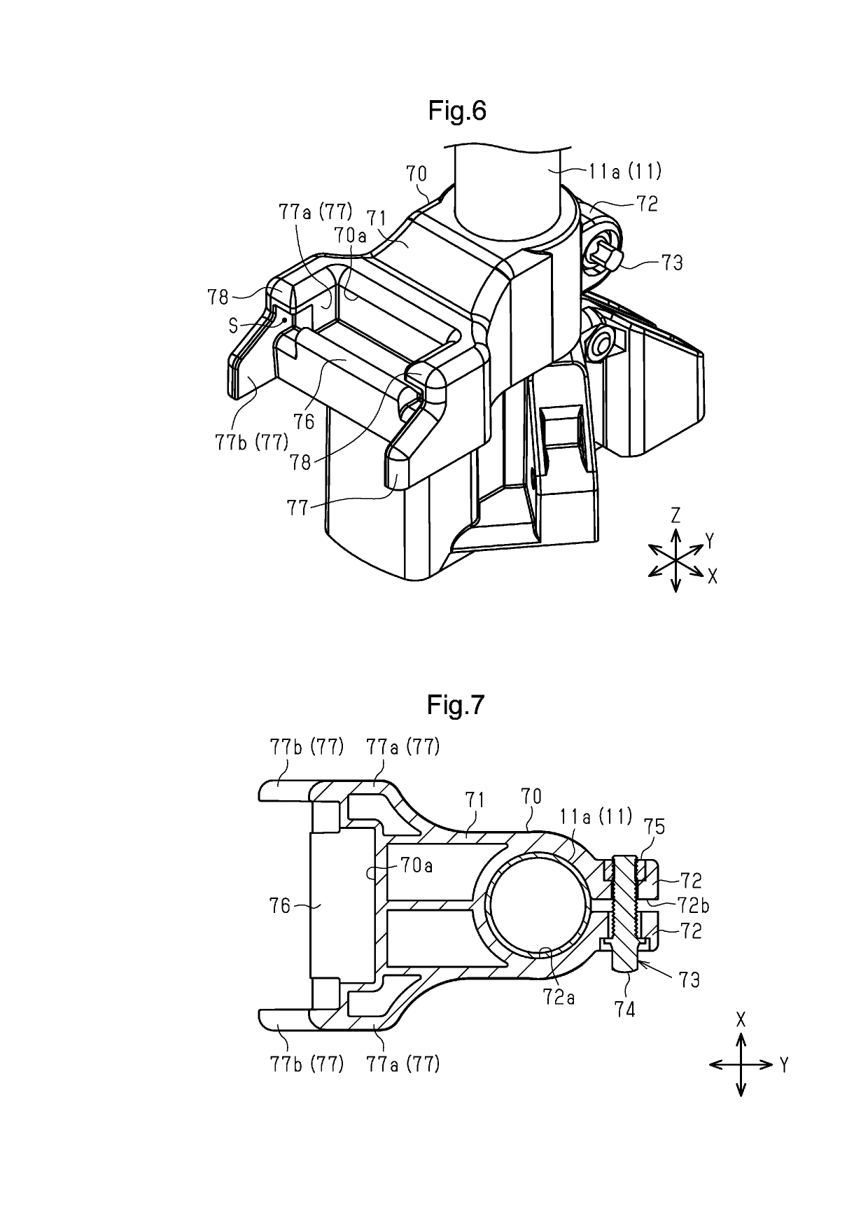

As shown in FIGS. 6 and 7, the bracket 70 has a basal portion 71, two clamping portions 72, and a tightening portion 73. The clamping portions 72 extend frontward from the basal portion 71 and sandwich the support column 11a. The tightening portion 73 tightens the clamping portions 72.

As shown in FIG. 7, the clamping portions 72 form a circular holding hole 72a for holding the support column 11a, and a slit 72b continuous with the holding hole 72a. The slit 72b extends over the entire extent in the Z-axis direction of the bracket 70.

The tightening portion 73 includes a bolt 74, which extends through the clamping portions 72 in the X-axis direction, and a nut 75, which is embedded in one of the clamping portions 72. The tightening portion 73 can change the amount by which the bolt 74 is threaded into the nut 75, thereby changing the amount by which the clamping portions 72 tighten the support column 11a.

The bracket 70 is attachable to the support column 11a by tightening the clamping portions 72 with the tightening portion 73. The bracket 70 is also configured such that the attachment position in the length direction of the support column 11a can be changed by loosening the tightening portion 73.

As shown in FIGS. 4 to 6, the bracket 70 includes a support portion 76, two restriction walls 77, and two retention portions 78.

As shown in FIG. 6, the support portion 76 is a protrusion extending in the X-axis direction and protruding upward from the rear end portion of the bracket 70. A recess 70a, which opens upward, is formed between the basal portion 71 and the support portion 76 in the Y-axis direction.

As shown in FIG. 4, the upper surface of the support portion 76 is curved in an arcuate shape from one side to the other side in the Y-axis direction. The support portion 76 supports the first section 27 of the protruding portion 26 from below through the cushioning member 80. In other words, the extension portion 24 is hooked onto the support portion 76 from above.

The support portion 76 faces the restriction portion 25 of the extension portion 24 in the Y-axis direction. More specifically, the support portion 76 supports the front surface of the restriction portion 25 from the front through the cushioning member 80.

As shown in FIG. 6, the restriction walls 77 extend rearward from the basal portion 71 and face each other in the X-axis direction with the support portion 76 in between. The restriction walls 77 extend rearward beyond the support portion 76. Clearances are formed between the opposite ends in the X-axis direction of the support portion 76 and the restriction walls 77.

The restriction walls 77 form the recess 70a together with the basal portion 71 and the support portion 76. The recess 70a accommodates the second section 28 of the extension portion 24 supported by the support portion 76 (see FIG. 4).

As shown in FIG. 2, in a state in which the bracket 70 supports the extension portion 24, the restriction walls 77 cover the extension portion 24 from the opposite sides in the X-axis direction. The restriction walls 77 restrict movement of the extension portion 24 to the opposite sides in the X-axis direction.

As shown in FIG. 6, each restriction wall 77 includes a thick portion 77a, which extends rearward from the basal portion 71, and a thin portion 77b, which extends rearward from the thick portion 77a. The thickness of the thin portion 77b in the X-axis direction is less than the thickness of the thick portion 77a in the X-axis direction. The inner surface in the X-axis direction of the thin portion 77b is located outward in the X-axis direction of the inner surface in the X-axis direction of the thick portion 77a. An accommodation space S for accommodating a corner portion of the first section 27 of the extension portion 24 is formed between the inner surface of the thin portion 77b and the rear surface of the thick portion 77a, which is perpendicular to the inner surface of the thin portion 77b.

The retention portions 78 cover the respective accommodation spaces S, which are formed by the restriction walls 77, from above. Each retention portion 78 protrudes toward the accommodation space S from the boundary between the upper end of the thick portion 77a and the upper end of the thin portion 77b.

As shown in FIG. 5, the retention portions 78 retain two corner portions of the first section 27, which is accommodated in the accommodation spaces S, from above. The front surfaces of the corner portions of the first section 27 face the rear surfaces of the thick portions 77a in the Y-axis direction.

As shown in part (a) of FIG. 8, the bass drum pad 12 is configured to be separated from the installation surface FL of the pedal device 17 when the extension portion 24 is supported by the support portion 76 from below and the clamped portion 22 is sandwiched by the clamp 17b.

### Operation of Bass Drum Pad 12

As shown in parts (a) and (b) of FIG. 8, when the pad body 31 is not being struck, the first impact absorption portion 61 urges the push plate portion 39 of the stopper 37 upward. In other words, when the pad body 31 is not being struck, the impact receiving unit 30 is urged in the direction opposite to the guide direction. The push plate portion 39 is opposed to the opposing portion 29 in the direction opposite to the guide direction. Thus, the push plate portion 39 is urged toward the opposing portion 29 by the first impact absorption portion 61. At this time, the cylindrical second impact absorption portion 62 is compressed from below by the push plate portion 39 and is thus flattened. The compressed second impact absorption portion 62 restricts the rotation of the impact receiving unit 30 in the direction opposite to the guide direction.

The magnitude of the elastic force of the first impact absorption portion 61 is set such that the second impact absorption portion 62 is compressed by the push plate portion 39 when the pad body 31 is not being struck. The magnitude of the elastic force of the first impact absorption portion 61 can be adjusted by making the length in the X-axis direction and the thickness of the first impact absorption portion 61 different from those of the second impact absorption portion 62.

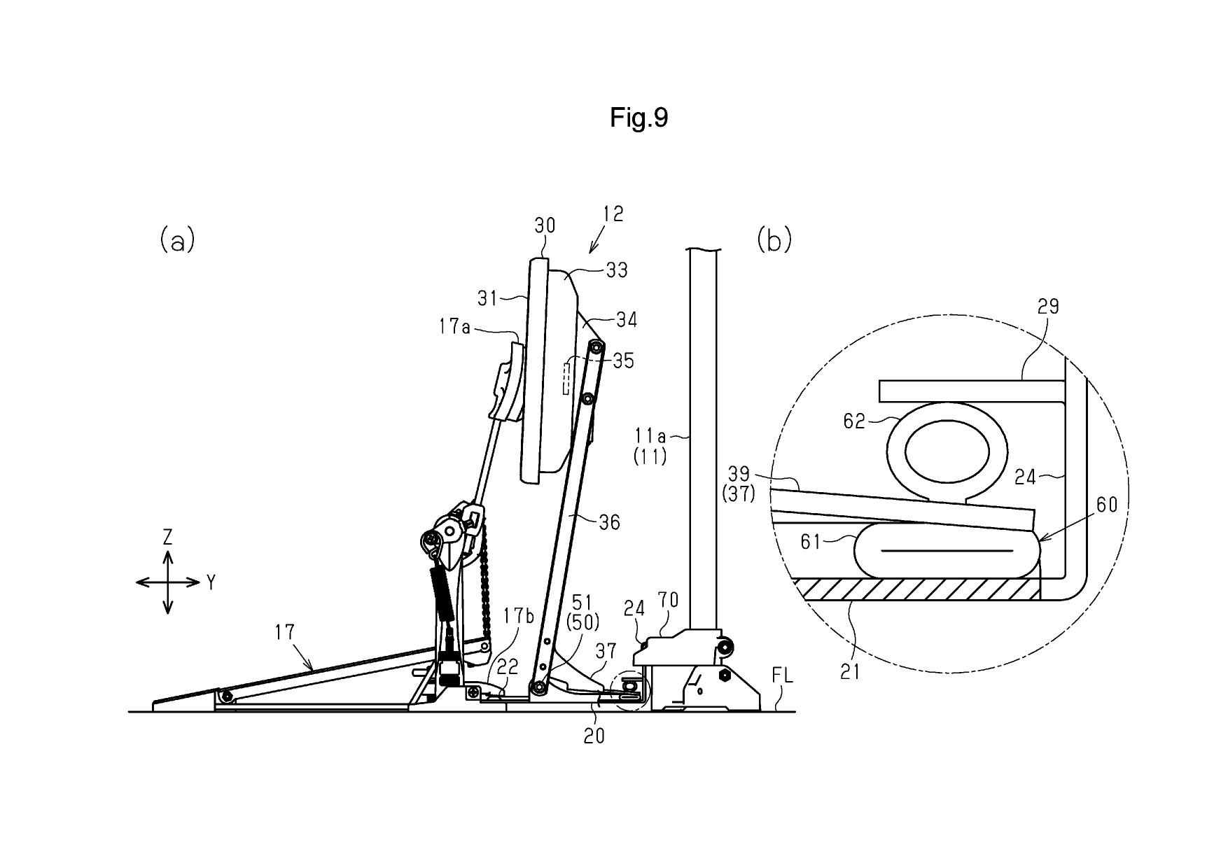

As shown in parts (a) and (b) of FIG. 9, when the beater 17a strikes the pad body 31, the impact receiving unit 30 rotates around the support shaft 51 in the guide direction. At this time, the cylindrical first impact absorption portion 61 is compressed from above by the push plate portion 39 and is thus flattened. Also, the second impact absorption portion 62, which has been compressed into a flat shape by the push plate portion 39, becomes cylindrical due to its restoring force. The compressed first impact absorption portion 61 restricts the rotation of the impact receiving unit 30 in the guide direction. In this manner, the first and second impact absorption portions 61 and 62 restrict the range of rotation of the impact receiving unit 30 about the support shaft 51.

The push plate portion 39 compresses the first impact absorption portion 61 in response to the striking on the pad body 31 by the beater 17a, and is then returned by the restoring force of the first impact absorption portion 61 to the position where it rests while the pad body 31 is not struck. The push plate portion 39 compresses the second impact absorption portion 62 as it returns. In this manner, the striking on the pad body 31 causes the impact receiving unit 30 to rotate in the both rotation directions about the support shaft 51.

### Operation of the Present Embodiment

When the pad body 31 is struck by the beater 17a, the impact receiving unit 30 moves in the guide direction of the guide mechanism 50 relative to the support 20. As such, when the beater 17a strikes the pad body 31, the impact receiving unit 30 is less likely to move in a direction different from the guide direction. The cushion member 60, which is placed between the impact receiving unit 30 and the support 20, absorbs the impact of the impact receiving unit 30 moving in the guide direction.

### Advantages of the Present Embodiment

(1) The bass drum pad 12 includes the support 20, the impact receiving unit 30, the guide mechanism 50, and the cushion member 60. The impact receiving unit 30 includes the pad body 31, which is struck by the beater 17a. The impact receiving unit 30 is supported so as to be movable relative to the support 20. The guide mechanism 50 guides the impact receiving unit 30 to move in the guide direction relative to the support 20 when the pad body 31 is struck. The cushion member 60 is placed between the impact receiving unit 30 and the support 20. The cushion member 60 absorbs the impact applied to the impact receiving unit 30.

According to the configuration described above, the player is likely to feel uniform sensations when striking the pad body 31 with the beater 17a. As a result, the player is less likely to experience a sense of discomfort.

Also, the cushion member 60 is placed between the impact receiving unit 30 and the support 20. This limits generation of contact noise between the impact receiving unit 30 and the support 20 when the beater 17a strikes the pad body 31. The bass drum pad 12 therefore produces less noise when struck.

(2) The guide mechanism 50 includes the support shaft 51, which supports the impact receiving unit 30 such that the impact receiving unit 30 is rotatable relative to the support 20 about the axis A. The support shaft 51 guides the impact receiving unit 30 to move in the guide direction that is one of the rotation directions about the axis A.

According to the configuration described above, the guide mechanism 50 has a simpler configuration than a configuration in which the guide mechanism 50 guides the impact receiving unit 30 in the horizontal direction.

(3) The impact receiving unit 30 includes two arms 36, which extend from the support shaft 51. The pad body 31 is fixed is fixed to the arm 36.

According to the configuration described above, when the pad body 31 is struck by the swinging beater 17a, the impact receiving unit 30 rotates about the support shaft 51. The striking direction of the beater 17a is tangential to the rotation of the beater 17a during swinging. In order for the player of the bass drum pad 12 to obtain a feeling similar to that of playing a bass drum, the pad body 31 may move in the striking direction of the beater 17a at the moment when the pad body 31 is struck. According to the above configuration, the rotation radius of the pad body 31 is increased by lengthening the arms 36 extending from the support shaft 51, thereby increasing the range in which the tangential direction during rotation of the pad body 31 substantially agrees with the striking direction of the beater 17a. This allows the moving direction of the pad body 31 to approximate the striking direction of the beater 17a, enabling the player to experience a feeling similar to that of playing a bass drum.

(4) The push plate portion 39 of the stopper 37 is configured to compress the first impact absorption portion 61 of the cushion member 60 when the impact receiving unit 30 rotates about the axis A.

According to this configuration, when the impact receiving unit 30 rotates in response to the striking of the pad body 31, the push plate portion 39 compresses the first impact absorption portion 61. Accordingly, the vibration caused by striking the pad body 31 is less likely to be transmitted through the support 20 to the installation surface FL of the pedal device 17.

Furthermore, according to the above configuration, even when the striking position of the beater 17a varies, the striking motion is uniformly converted into rotational movement of the arms 36, thereby limiting variation in the contact position between the stopper 37 and the first impact absorption portion 61. As a result, the player is less likely to experience a sense of discomfort.

(5) The push plate portion 39 of the stopper 37 is configured to move toward the upper surface of the support 20 as the impact receiving unit 30 rotates about the axis A. The first impact absorption portion 61 is placed between the stopper 37 and the upper surface of the support 20.

According to the above configuration, when the impact receiving unit 30 rotates in response to the striking of the pad body 31, the stopper 37 compresses the first impact absorption portion 61 from above. Thus, the impact transmitted from the beater 17a to the impact receiving unit 30 is more easily released downward. As a result, the bass drum pad 12 is less likely to move horizontally, as compared with a configuration in which the first impact absorption portion 61 is compressed in the horizontal direction in response to an impact by the beater 17a.

Furthermore, according to the above configuration, the stopper 37 is moved toward the support 20 by the rotation of the impact receiving unit 30 about the axis A of the support shaft 51. This limits the size of the bass drum pad 12 in the direction along the support shaft 51, that is, the X-axis direction, as compared with a configuration in which the stopper 37 extends from the arms 36 along the support shaft 51.

(6) The second impact absorption portion 62 is placed between the opposing portion 29 and the stopper 37.

According to this configuration, the second impact absorption portion 62 is placed between the stopper 37 and the opposing portion 29 located above the stopper 37. As such, when the restoring force of the compressed first impact absorption portion 61 acts on the stopper 37 and causes the arms 36 to rotate in the direction opposite to the guide direction, the stopper 37 is pressed against the second impact absorption portion 62. This enables the positioning of the impact receiving unit 30 in a state in which the pad body 31 is not being struck. Thus, the player is less likely to experience variations in sensation while repeatedly striking the pad body 31 with the beater 17a.

Also, the configuration described above limits generation of contact noise between the stopper 37 and the opposing portion 29 when the arms 36 rotate in the direction opposite to the guide direction.

(7) The cushion member 60 is made of rubber. The first impact absorption portion 61 has the shape of a hollow cylinder having a central axis extending in the horizontal direction.

The magnitude of the elastic force generated when rubber is compressed depends on the hardness of the rubber. However, variations in the hardness of rubber result in variations in the magnitude of the elastic force generated when the rubber is compressed.

In this regard, according to the configuration described above, the first impact absorption portion 61 is made of rubber and has a hollow cylindrical shape. As such, in addition to the elastic force generated by the compression of the rubber, an elastic force generated by the rubber being deformed to occupy the space of the hollow section acts on the first impact absorption portion 61. The magnitude of the elastic force generated by the deformation of rubber depends on the shape of the rubber. This makes it easier to ensure the elastic force required for the first impact absorption portion 61 even when there is variation in the hardness of the rubber.

Also, according to the above configuration, since the cushion member 60 is made of rubber, the cushion member 60 can be embodied with a simple configuration.

(8) The bass drum pad 12 includes the vibration sensor 35.

If the impact receiving unit 30 that is struck by the beater 17a moves not only in the guide direction but also in a direction different from the guide direction, the detection accuracy of the vibration sensor 35 may decrease.

In this regard, the guide mechanism 50 of the above configuration can limit movement of the impact receiving unit 30 in directions other than the guide direction when the beater 17a strikes the impact receiving unit 30. This limits a decrease in the detection accuracy of the vibration sensor 35.

(9) The bass drum pad 12 is configured to be separated from the installation surface FL of the pedal device 17 when the extension portion 24 is supported by the support portion 76 from below and the clamped portion 22 is sandwiched by the clamp 17b.

According to the above configuration, the extension portion 24 is supported by the support portion 76 of the bracket 70 attached to the support column 11a of the stand 11, and the clamped portion 22 is sandwiched by the clamp 17b, so that the bass drum pad 12 is separated from the installation surface FL. This limits transmission of the vibration of the struck pad body 31 to the installation surface FL, so that the player is less likely to feel the vibration. As a result, the player is less likely to experience a sense of discomfort.

Also, the bass drum pad 12 is separated from the installation surface FL, thereby limiting generation of contact noise between the bass drum pad 12 and the installation surface FL when the beater 17a strikes the pad body 31. The bass drum pad 12 therefore produces less noise when struck.

(10) The extension portion 24 includes the restriction portion 25 and the protruding portion 26. The restriction portion 25 is on the opposite side of the bracket 70 from the support column 11a. The restriction portion 25 is opposed to the bracket 70 and restricts movement of the support 20 toward the support column 11a. The support portion 76 supports the protruding portion 26, which protrudes from the restriction portion 25 toward the bracket 70, from below.

If the position of the bass drum pad 12 relative to the other pads in the electronic drum set 10 changes while the bass drum pad 12 is played, the player may find it difficult to play the bass drum pad 12.

In this regard, according to the above configuration, in a state in which the protruding portion 26 is supported by the support portion 76, the restriction portion 25 is opposed to the bracket 70 on the side opposite from the support column 11a. This restricts movement of the bass drum pad 12 toward the support column 11a due to the impact caused when the pad body 31 is struck. Thus, the position of the bass drum pad 12 relative to the other pads is less likely to change. Also, this eliminates the need for an additional structure for fixing the bass drum pad 12 to the installation surface FL.

(11) The bracket 70 has the retention portions 78, which retain the extension portion 24 from above.

When the pad body 31 is struck hard, the stopper 37 that has compressed the first impact absorption portion 61 may rotate rapidly in the direction opposite to the guide direction due to the reaction force generated by the compression. At this time, the impact generated when the stopper 37 compresses the second impact absorption portion 62 from below acts to lift the bass drum pad 12 upward.

In this regard, according to the above configuration, the extension portion 24 is retained by the retention portions 78 from above and is thus unlikely to be lifted from the bracket 70 due to the impact when the pad body 31 is struck. Thus, the position of the bass drum pad 12 relative to the stand 11 is less likely to change.

(12) The cushioning member 80 is attached to the section of the extension portion 24 that comes into contact with the bracket 70.

This configuration can limit generation of contact noise between the extension portion 24 and the bracket 70 when the pad body 31 is struck.

(13) The bracket 70 is configured so that the attachment position in the length direction of the support column 11a is changeable.

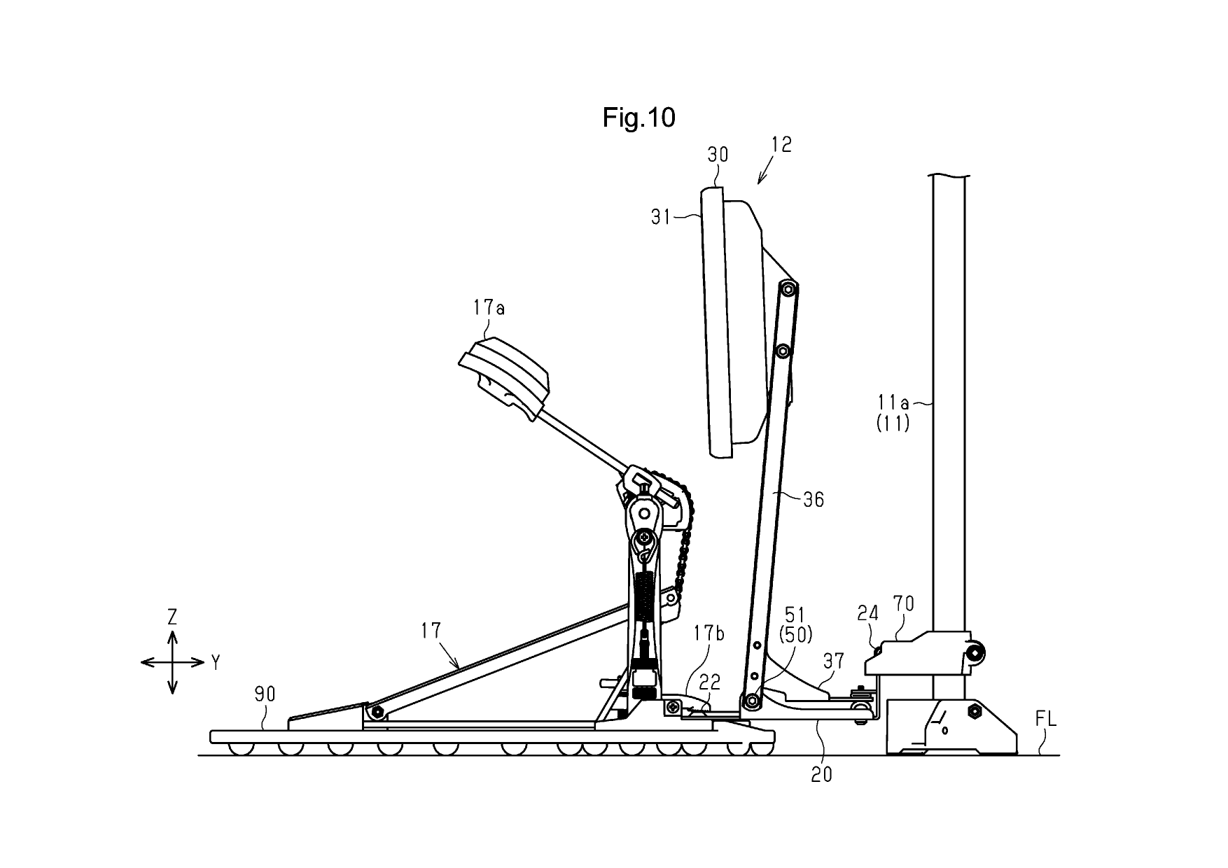

According to this configuration, the height position of the bass drum pad 12 from the installation surface FL can be changed by changing the attachment position of the bracket 70 in the length direction of the support column 11a. As a result, as shown in FIG. 10, even when a vibration isolation member 90 is placed between the pedal device 17 and the installation surface FL resulting in a change in the height position of the pedal device 17, the clamp 17b of the pedal device 17 can still sandwich the clamped portion 22. Additionally, even when different types of pedal devices with varying clamp height positions are used, the clamped portion 22 can be sandwiched by the clamps of these pedal devices. This increases the versatility of the bass drum pad 12.

### Modifications

The present embodiment may be modified and implemented as follows. The embodiment and the following modifications may be combined to an extent that does not cause technical contradiction.

The bracket 70 does not necessarily need to be configured such that the attachment position in the length direction of the support column 11a is changeable. The bracket 70 may be engaged with the support column 11a and attached so as not to move relative to the support column 11a at a predetermined position.

The cushioning member 80 does not necessarily need to be attached to the extension portion 24.

The bracket 70 may be configured to retain the protruding portion 26 from above with a single retention portion 78. In this case, the retention portion 78 may retain the center portion in the X-axis direction of the protruding portion 26 from above.

The bracket 70 does not necessarily need to include the retention portions 78.

The extension portion 24 does not necessarily need to include the restriction portion 25. In this case, the support 20 may include a protruding portion 26 that protrudes forward from the front end of the base portion 21.

The bass drum pad 12 does not necessarily need to include the bracket 70. In this case, the bass drum pad 12 does not need to be connected to the support column 11a. Also, the support 20 does not necessarily need to include the clamped portion 22. In this case, the bass drum pad 12 may be placed on the installation surface FL. This configuration still achieves advantages equivalent to advantages (1) to (8) described above.

The bass drum pad 12 may be a bass drum pad for practice that does not include the vibration sensor 35.

The first impact absorption portion 61 may be made of an elastic material other than rubber. This modification can be similarly applied to the second impact absorption portion 62.

The shape of the first impact absorption portion 61 can be changed to various shapes such as a solid columnar shape. This modification can be similarly applied to the second impact absorption portion 62.

The bass drum pad 12 does not necessarily need to include the second impact absorption portion 62. In this case, the push plate portion 39 is still pressed against the opposing portion 29 by the urging force of the first impact absorption portion 61. This enables the positioning of the impact receiving unit 30 in a state in which the pad body 31 is not being struck.

The bass drum pad 12 does not necessarily need to include the second impact absorption portion 62 and the opposing portion 29.

The stopper 37 may extend from the arms 36 in the X-axis direction. In this case, the support 20 may have a shape that supports the cushion member 60 so that the cushion member 60 is placed in front of the stopper 37.

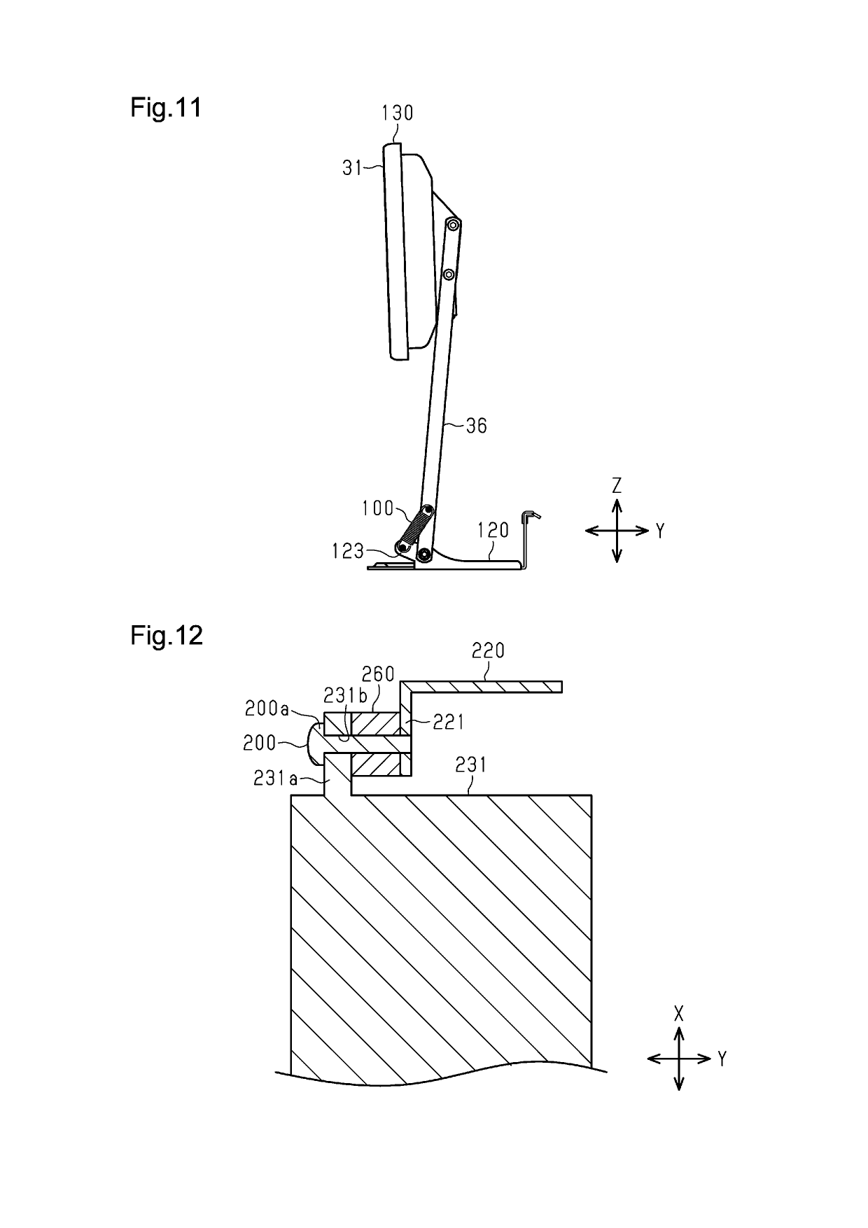

The impact receiving unit 30 does not necessarily need to include the stopper 37. In this case, as shown in FIG. 11, an impact receiving unit 130 may include a tension coil spring 100, which urges the impact receiving unit 130 in the direction opposite to the guide direction, for example. The impact receiving unit 130 of this modification includes a support 120 having a support wall 123 extending to a position rearward of the arm 36 in the Y-axis direction. The tension coil spring 100 connects the arm 36 to the rear end of the support wall 123. In this modification, the rotation of the impact receiving unit 130 in the guide direction expands the tension coil spring 100. This absorbs the impact acting on the impact receiving unit 130.

The support shaft 51 may be placed above the pad body 31. In this case, the arms 36 extend downward from the support shaft 51, for example. When the pad body 31 is struck, the stopper 37 compresses the cushion member 60 from below.

The bass drum pad 12 does not necessarily need to include the arms 36 and the support shaft 51. In this case, as shown in FIG. 12, a pad body 231 may be connected to a support 220 through a shaft 200 extending in the Y-axis direction. In this modification, the shaft 200 is inserted in a through-hole 231b of an attachment portion 231a extending outward from the pad body 231. The front end of the shaft 200 is fixed to a reception portion 221 of the support 220. The rear end of the shaft 200 includes an enlarged portion 200a, which is larger than the section of the shaft 200 that is inserted in the through-hole 231b. The reception portion 221 is located frontward of the attachment portion 231a. A cylindrical cushion member 260, in which the shaft 200 is inserted, is placed between the attachment portion 231a and the reception portion 221. The cushion member 260 urges the attachment portion 231a toward the enlarged portion 200a. The cushion member 260 may be made of rubber, for example. The shaft 200 allows the pad body 231 to slide in the axial direction of the shaft 200, while restricting the movement of the pad body 231 in a direction different from the axial direction of the shaft 200. Thus, the shaft 200 guides the pad body 231 to move forward when the pad body 231 is struck. When the pad body 231 moves forward while sliding on the shaft 200, the attachment portion 231a compresses the cushion member 260. The pad body 231 that has moved forward is moved rearward by the restoring force of the cushion member 260 and is pressed against the enlarged portion 200a. This limits vibration of the pad body 231 after impact. The shaft 200 is an example of a guide mechanism. The cushion member 260 is an example of an impact absorption portion. The enlarged portion 200a is an example of an opposing portion. In this configuration, the cushion member 260 urges the pad body 231 toward the enlarged portion 200a. As such, the pad body 231 that has moved in the guide direction in response to an impact on the pad body 231 is moved in the direction opposite to the guide direction by the urging force of the cushion member 260 and is pressed against the enlarged portion 200a. This enables the positioning of the pad body 231 in a state in which the pad body 231 is not being struck. Thus, the player is less likely to experience variations in sensation while repeatedly striking the pad body 231 with the beater 17a. FIG. 12 shows one end portion in the X-axis direction of the pad body 231, and the present modification has the above configuration at multiple locations on the outer circumference of the pad body 231. The cushion member 260 may be placed between the attachment portion 231a and the reception portion 221 at a position away from the shaft 200. In this case, the cushion member 260 may have the shape of a solid column.

The bass drum pad 12 does not necessarily need to include the guide mechanism 50 and the cushion member 60. In this case, the impact receiving unit 30 may be supported on the support 20 so as to be immovable. This configuration still achieves advantages equivalent to advantages (9) to (13) described above as long as the bass drum pad 12 includes the impact receiving unit 30 and the bracket 70.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A bass drum pad configured to be played using a pedal device including a beater that swings in response to a stepping operation by a player, the bass drum pad comprising:
a support;
an impact receiving unit including a pad body that is configured to be struck by the beater, the impact receiving unit being supported so as to be movable relative to the support;
a guide mechanism that is configured to guide the impact receiving unit to move in a guide direction relative to the support when the pad body is struck; and
an impact absorption portion placed between the impact receiving unit and the support to absorb an impact acting on the impact receiving unit.

2. The bass drum pad according to claim 1, further comprising
an opposing portion that is opposed to the impact receiving unit in a direction opposite to the guide direction,
wherein the impact receiving unit is urged toward the opposing portion by the impact absorption portion.

3. The bass drum pad according to claim 1, wherein
the guide mechanism includes a support shaft that supports the impact receiving unit such that the impact receiving unit is rotatable relative to the support about an axis extending in a horizontal direction, and
the support shaft is configured to guide the impact receiving unit to move in the guide direction that is one of rotation directions about the axis.

4. The bass drum pad according to claim 3, wherein
the impact receiving unit includes an arm that extends from the support shaft in a direction intersecting the axis, and
the pad body is fixed is fixed to the arm.

5. The bass drum pad according to claim 4, wherein
the impact receiving unit includes a stopper that extends from the arm and rotates together with the arm, and
the stopper is configured to compress the impact absorption portion in response to the impact receiving unit rotating about the axis.

6. The bass drum pad according to claim 5, wherein
the stopper is opposed to an upper surface of the support and is configured to move toward the upper surface of the support in response to the impact receiving unit rotating about the axis, and
the impact absorption portion is placed between the stopper and the upper surface of the support.

7. The bass drum pad according to claim 6, wherein
the impact absorption portion is a first impact absorption portion,
the support includes an opposing portion that is located above the stopper and is opposed to the stopper, and
the bass drum pad further comprises a second impact absorption portion placed between the opposing portion and the stopper.

8. The bass drum pad according to claim 5, wherein
the impact absorption portion is made of rubber, and
the impact absorption portion has a shape of a hollow cylinder having a central axis extending in the horizontal direction.

9. The bass drum pad according to claim 1, wherein the impact absorption portion is made of rubber.

10. The bass drum pad according to claim 1, wherein the bass drum pad is an electronic bass drum pad including a vibration sensor configured to detect vibration of the pad body.

11. A bass drum pad configured to be played using a pedal device including a beater that swings in response to a stepping operation by a player, the bass drum pad comprising:
a support;
an impact receiving unit including a pad body that is configured to be struck by the beater, the impact receiving unit being supported by the support; and
a bracket attachable to a support column of a stand supporting a percussion instrument that is different from the bass drum pad, wherein
the support includes an extension portion extending toward the bracket and a clamped portion that is configured to be sandwiched from above and below by a clamp of the pedal device,
the bracket includes a support portion that supports the extension portion from below, and
the bass drum pad is configured to be separated from an installation surface of the pedal device when the extension portion is supported by the support portion from below and the clamped portion is sandwiched by the clamp.

12. The bass drum pad according to claim 11, wherein
the extension portion includes:
a restriction portion that is located on an opposite side of the bracket from the support column and is opposed to the bracket to restrict movement of the support toward the support column; and
a protruding portion extending from the restriction portion toward the bracket, and
the support portion supports the protruding portion from below.

13. The bass drum pad according to claim 11, wherein the bracket includes a retention portion that retains the extension portion from above.

14. The bass drum pad according to claim 11, wherein a cushioning member is attached to a section of the extension portion that comes into contact with the bracket.

15. The bass drum pad according to claim 11, wherein the bracket is configured such that an attachment position in a length direction of the support column is changeable.
